(19) United States
(12) Patent Application Publication
(10) Pub. No.: US 2013/0000931 A1
(43) Pub. Date: Jan. 3, 2013

(54) Dual Blade Parallel Garden Hoe

(76) Inventors: Kelly Wroolie, Brainard, MN (US); William Wroolie, Brainerd, MN (US)

(21) Appl. No.: 13/287,165

(22) Filed: Nov. 2, 2011

Related U.S. Application Data
(60) Provisional application No. 61/502,134, filed on Jun. 28, 2011.

(51) Int. Cl. A01B 1/10

(52) U.S. Cl. 172/373; 172/371

(57) ABSTRACT

A dual blade garden hoe device is disclosed having a working end mounted to an elongated handle. The working end of the device comprises a perpendicular shaft that creates a T-junction with the handle. A pair of parallel blades is secured onto the perpendicular shaft and disposed at a variable pitch. The blades position along the length of the shaft is adjustable to create different widths between blades. The blades extended downward to provide a dual-hoe device that is adapted to create a pair of parallel troughs through soil, particularly suited for garden beds or farms wherein seed is placed in parallel rows. The parallel blades are oriented from the device such that when the blades are in contact with the working surface, each blade will create a separate and parallel trough, thereby reducing time and effort in making a systematic garden design or alignment of farming rows.

### CROSS REFERENCE TO RELATED APPLICATION

This application claims the benefit of U.S. Provisional Application No. 61/502,134 filed on Jun. 28, 2011, entitled “Parallel Garden Hoe.”

### BACKGROUND OF THE INVENTION

1. Field of the Invention

The present invention relates to the field of garden and farming tools. More specifically, the present invention pertains to a handheld tool that provides a variable pitch and dual-headed garden hoe for parallel farming row creation with a single pass.

While gardening implements have become more technologically advanced, there is still a need for manual gardening devices. The common garden hoe is still one of the most widely used manual gardening devices. Garden hoes generally chop weeds and soil, work the surface of the soil and cut weed roots below the surface. Standard garden hoes, however, permit work accomplished at a rather slow rate of speed. A single blade is employed to work the soil in a single direction, requiring movement around the plants by the user to operate the hoe in various directions or a single blade is employed to create troughs prior to laying down seed.

Farming rows are commonly used to create parallel lines of a particular harvest, with a trough separating each row to allow room for growth and for access to each row by a farmer, harvester or mechanism in service therefor. The use of organized rows also maximizes the use of a given area of land, allowing the most crops to be harvested at once if desired. Garden areas are usually built such that there is an aligned order to the way plants or vegetables are planted. Gardeners prefer to have even rows to walk through and adequate space to till in their gardens. This is true even if the area is not in a rectangular or square shape. This idea of even rows improves the appearance of the garden, allows the plants to flourish and is the most efficient way to seed a patch of earth. Planting in rows allows for a systematic way of getting the most planting space from a particular area. The space between rows is dependent on the specific crop and the space required by the gardener or farmer resulting from an expected growth size of plants in each row.

In the past a variety of tools have been used for the purpose of tilling and creating organized rows on a farm or garden. Unfortunately prior garden hoe devices available do not allow for multiple rows to be plowed manually at one time. A user must work one row at a time and spend additional time aligning consecutive rows, which often includes use of additional tools and methods to make sure the rows are parallel with each other. Such procedures result in increased time and effort producing a uniform plot of land for gardening, which can result in loss of productivity.

The present invention solves these problems by providing a means for tilling soil manually with a handheld implement that comprises a plurality of aligned garden hoes. The aligned garden hoes are disposed on working end of an elongated shaft, which allow multiple troughs and multiple locations to be tilled simultaneously and in a parallel configuration. The specific implement may be substituted for a different style hoe, depending on the user preferences and needs, given the type of soil and the specific task. However, the implements are secured along a common rail and aligned in parallel with one another, allowing one user to increase productivity and produced aligned rows within a garden or larger farm. The present invention further reduces the time spent struggling lining up rows while creating troughs for plants or vegetables to be planted.

2. Description of the Prior Art

The prior art contains several multi blade devices for cutting through a working surface. These devices have familiar design and structural elements for the purposes of cutting through a working surface; however they are not structured for manual use of multiple blades cutting through a working surface at two distinct areas and by the most efficient means.

U.S. Pat. No. 6,152,241 to Johnson discloses a dual blade garden hoe. The hoe includes a head and a handle. The head has a longitudinal base to which two blades are mounted. The two long blades are positioned perpendicular to the handle and base and are connected at approximately the mid-point of the blades. The handle is mounted to the base and oriented at an acute angle to the working surface when the cutting edges are in contact with the working surface. The two blades are working across from each blade on the same large piece of working surface in order to cultivate and weed. This type of device is not adapted to creating parallel rows for planting, but rather this device is used more for general soil tilling and weed removal. This device is wide in surface area so it is not conducive to working within confined spaces such as rows meant for planting. Further, the orientation of the blades does not allow a user to push or pull the device to create evenly spaced rows for planting seeds or creating parallel troughs. The operation of the device and its structure are divergent from the present invention.

U.S. Pat. No. 4,077,479 to Tibbs describes cultivator plow sweeps with extended vertical vanes connected by a brace. Each sweep is provided with a vertical vane, a rigidifying brace may be provided extending between the vanes. The sweeps are meant to provide support in the digging of soil over an area on land. The sweeps work over a particular space along the ground that is in need of tilling. A cultivator works on a larger scale than a standard garden hoe. Most cultivators are drawn as an attachment behind a tractor. While suited for its particular purpose and requirements, this device is not meant for manual working soil in a garden or for creating parallel rows therein.

The devices disclosed in the prior art do not address the need for a handheld tilling device that allows multiple, parallel rows to be simultaneously created for later seeding and harvesting. The present invention relates to a device that allows for multiple troughs or farming rows to be created in one action, using a handheld device similar to a standard garden hoe. The device provides a plurality of tilling implements, which can be removed and replaced with different types and positioned at a desired separation distance. The structure and intent of the present invention substantially diverges in design elements from the prior art, and consequently it is clear that the present invention is not described by the prior art and that a need exists for an improved garden hoe device that provides an efficient method of creating parallel rows in soil for planting and tilling. In this regard the instant invention substantially fulfills these needs.

### SUMMARY OF THE INVENTION

In view of the foregoing disadvantages inherent in the known types of garden hoe devices now present in the prior art, the present invention provides a new means to work multiple rows of soil at one time using a handheld device. It is therefore an object of the present invention to provide a new and improved garden hoe device that has all of the advantages of the prior art and none of the disadvantages.

Another object of the present invention is to provide a new and improved garden hoe device that can till multiple rows at a time and in a parallel configuration, allowing multiple farming or gardening rows to be created with each pass through the soil by the user.

Yet another object of the present invention is to provide a new and improved garden hoe device that can use plurality of garden hoe implements at one time, and provide a modular attachment of each implement to allow the user to choose the distance between implements on the device.

Still another object of the present invention is to provide a new and improved garden hoe device that can be used with various types of garden hoe implements, wherein the working end may be configured with different style blades, hoes or similar implements as desired.

Another object of the present invention is to provide a new and improved garden hoe with adjustable distances between each hoe in order to provide the proper distance between planting rows of plants or vegetables.

A final object of the present invention is to provide a tool that provides a means to create parallel farming or gardening rows using a hand tool, reducing time and effort required to align rows and create a parallel pattern.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a preferred embodiment of the present invention.

FIG. 2 shows a close-up perspective view of the working end of a preferred embodiment of the present invention. The blades are shown in a position used for wider rows.

FIG. 3 shows a close-up perspective view of the working end of a preferred embodiment of the present invention. The blades are shown in a position used for narrower rows.

FIG. 4 shows a perspective view of a preferred embodiment of the present invention in use.

### DETAILED DESCRIPTION OF THE INVENTION

Reference is made herein to the attached drawings. Like reference numerals are used throughout the drawings to depict like or similar elements of the garden hoe device. For the purposes of presenting a brief and clear description of the present invention, the preferred embodiment will be discussed as used for creating a plurality of parallel garden rows in a simultaneous manner and using a single pass with a handheld implement. The figures are intended for representative purposes only and should not be considered to be limiting in any respect.

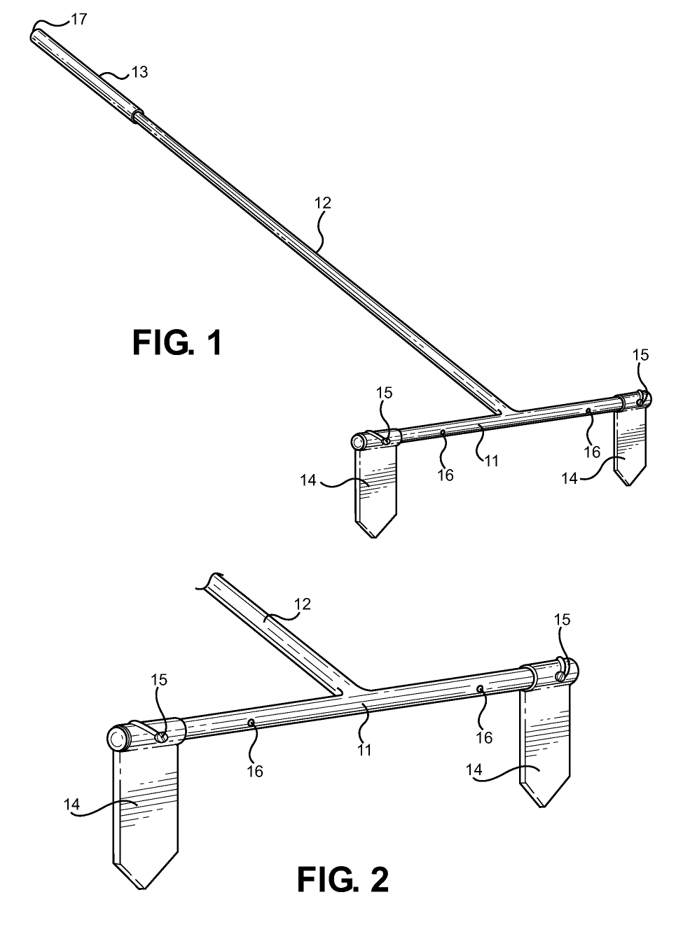

Referring now to FIG. 1, there is shown the parallel garden hoe device of the present invention. The device comprises a working end mounted to an elongated handle 12. The working end of the device comprises a shaft 11 that extends perpendicularly to the handle 12, wherein the handle 12 and the shaft 11 form a T-junction. The handle 12 is an elongated member that may further comprise a gripping surface 13 covering around its terminal end 17 in order for the user to have a more secure grip thereof. The grip may comprise of a high friction material or a soft, comfortable material to improve user comfort after prolonged use of the device. The handle itself may be adjustable in length to accommodate different sized users, or alternatively be of one-piece construction from handle through the working end. Two blades 14 are mounted to the perpendicular shaft 11 and in parallel to one another in order for the user to create two aligned troughs through a soil working surface. The handle 12 is disposed at an angle with respect to the blades 14 to facilitate proper tilling or trough creation.

The blades 14 have of the device preferably utilize triangular cutting edges in order to break through the soil working surface, while the widened body thereof allows soil to be pulled or pushed as necessary during the tilling operation. Alternate embodiments of the device include types of hoe blades for different types of working surfaces in order to better facilitate the placement of troughs or remove articles in the soil. The blades 14 are secured to the head of the device 11 via metal pins or fasteners 15. The blades 14 employ a rounded engagement region adapted to concentrically fit the device shaft 11 therethrough, while pin holes 16 are provided through the shaft 11 and the blade 14 such that pins 15 may be placed through the assembly and secure the blade 14 to the shaft 11. The pin 15 may comprise a threaded fastener, or alternatively a pin 15 with a smooth shank and a means for securing the shank in a static position through the shaft 11 and a first and second side of the blade rounded engagement region. The perpendicular shaft 11 provides a plurality of spaced pin holes 16 along its length to allow placement of the blades 14 at different distances from one another, depending on the user application and preferences.

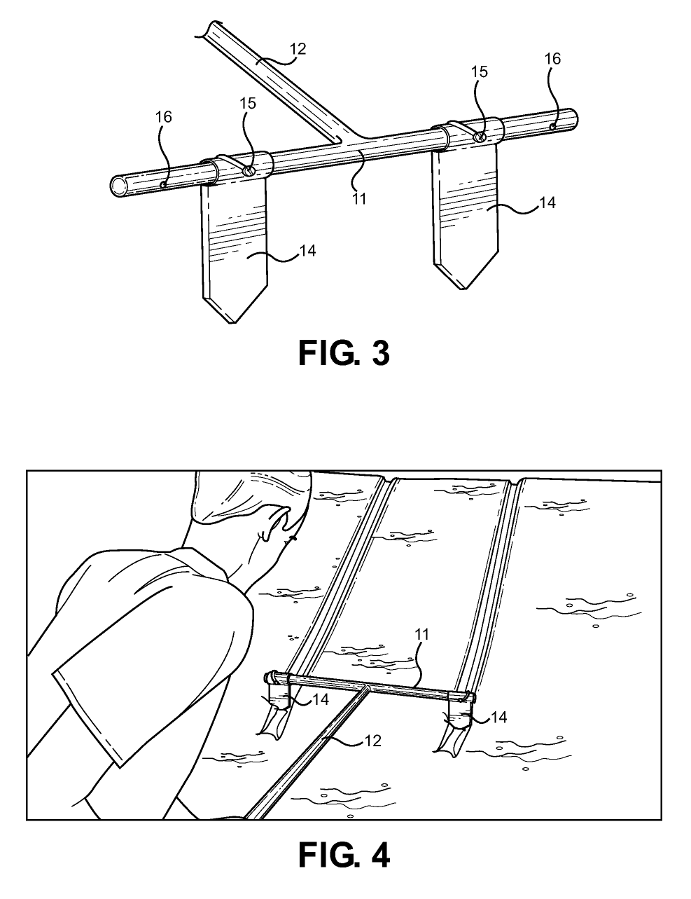

Referring now to FIG. 2, there is shown a close-up of the working end of the parallel garden hoe device. There are multiple positions along the working end of the garden hoe device where the blades 14 may be secured. The blades 14, in this illustration, are shown in the furthest most point along the perpendicular shaft 11 of the garden hoe device. Once a position is determined for the blades 14 based on the distance between rows that is required, the blades are then secured and locked into position by the attachment pins 15 through the holes 16 along the head of the device. The number and density of pin holes 16 is not desired to be limited, nor is the overall length of the perpendicular shaft 11. Referring now to FIG. 3, there is shown a second close-up view of the working end of the parallel garden hoe device. There are multiple positions along the perpendicular shaft of the garden hoe device wherein the blades 14 may be secured. In this figure, the blades 14 are shown in a position between the two outward extreme positions available.

Referring now to FIG. 4, there is shown the device in a working position from the perspective behind a user. The device is shown while it is being used for plowing or creating parallel troughs through a layer of soil. The user pulls the garden hoe device by the handle 12 in order to create two simultaneous and parallel troughs. The blades 14 that are attached to the working end of the device to create troughs that are evenly spaced along a given path. Both troughs are shown to be a specific distance, as determined by the user prior to beginning the plowing operation. The user has the ability with this device to create these multiple troughs at the same time without the use of additional items that would slow down the process, including rope lines or larger, more complex machines or devices. After the troughs have been created, the device may be turned over, whereby the user may cover seeds with dirt without the need to bend down or kneel. In this way, the troughs are created in a parallel and systematic fashion, and the seeding process can commence and be accomplished using the same device.

In use, an individual places the garden hoe device on top of a patch of soil. The user pushes or pulls the device in order to loosen the soil to make room to plant seeds. The spacing between the blades of the device is determined prior to use. If the spacing is not required for the given task, the attachment pins may be removed and the blades can be moved along the perpendicular shaft of the device to align with another hole, whereby the pins may be replaced to secure the blade position. The tool can further be turned over and used to cover seeds a layer of top soil, without the need to bend over, kneel or use a secondary device.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A garden hoe device, comprising:
an elongated handle with a first terminal end and a working end;
said working end having a perpendicular shaft mounted thereto forming a T-junction;
said perpendicular shaft having a plurality of blade locations for which to secure plurality of blade implements,
wherein said blade locations provide separate and distinct locations for securing said blade implements.

2. (canceled)

3. The device of claim 1, wherein:
said blade locations comprising pin holes through said shaft;
said blades having a rounded upper engagement region and a through hole from which to mount a securing pin through said engagement region and said perpendicular shaft pin hole.

4. The device of claim 3, wherein said securing pin further comprises a threaded fastener.

5. The device of claim 3, wherein said securing pin further comprises a smooth shank pin with a retainment means to prevent pin dislodgement,

6. The device of claim 1, wherein said handle first terminal end further comprises a grip surface to facilitate grip.

7. The device of claim 1, wherein said handle first terminal end further comprises a grip surface to facilitate comfort after prolonged use.

8. The device of claim 1, wherein said blades further comprise a triangular cutting edge.
